(19) United States
(12) Patent Application Publication
(10) Pub. No.: US 2010/0176063 A1
(43) Pub. Date: Jul. 15, 2010

(54) METHOD FOR COALESCENCE INDUCED LIQUID-LIQUID SEPARATIONS AND APPARATUS THEREOF

(76) Inventors: Yuri KOKOTOV, Maale Adumim (IL); Leonid BRAGINSKY, Maale Adumim (IL); David SHTEINMAN, Queens Park (AU); Shalom SLONIM, Haifa (IL)

Correspondence Address: Pearl Cohen Zedek Latzer, LLP, 1500 Broadway, 12th Floor, New York, NY, 10036, US

(21) Appl. No.: 12/352,195

(22) Filed: Jan. 12, 2009

(51) Int. Cl. B01D 17/04

(52) U.S. Cl. 210/708; 210/541; 210/319

(57) ABSTRACT

A method and apparatus for separating immiscible liquids effectively are provided in the present invention. Such method and apparatus may allow coalescing of relatively small-sized droplets into larger droplets for easing and improving the degree of separation thereafter. The method may be defined by a system of equations describing the requirements and conditions imposed on the kinetics of droplet breaking and coalescence as functions of properties of the involved liquids, involved energy, and means for inducing mixing energy into the mixture. According to the method, such means may include viscosity, interfacial tension, droplet diameter distribution, average droplet diameter, average volumetric droplet diameter, concentration of the dispersed liquid in the coalescing apparatus, restricting pressure of the electrostatic double layer surrounding the interfacial boundary of the droplets, and turbulent energy dissipation distribution per volume within the coalescing apparatus.

### FIELD OF THE INVENTION

The present invention relates to separations of immiscible liquids. More specifically, the present invention relates to method for coalescence induced liquid-liquid separations and apparatus thereof.

### BACKGROUND OF THE INVENTION

Many industrial processes involve mixtures of immiscible liquids. In some cases, the mixing of two liquids is necessary to obtain mass transfer between the phases or to promote a chemical reaction, but in others, it is an unintended or unavoidable result of the process.

Almost always, a full separation of the liquids may be important for efficient and cost effective performance of the downstream process.

Physical properties such as the size of the droplets (dispersed phase), the pH of the liquid mixture, and temperature variations within the liquid mixture are important and may completely alter the characteristics and ease of the separation process. Furthermore, the presence of solids and/or trace impurities within the liquid mixture may also increase the complexity of the separation process, and equally important is the size of the droplets since a given liquid-liquid separator has a minimum droplet size (dₘᵢₙ) that can efficiently be separated in the device.

### SUMMARY OF THE INVENTION

There is thus provided, in accordance with some embodiments of the present invention, a method for coalescing droplets having a diameter d, said diameter d having a value of d* or larger in a given coalescing apparatus. The method includes: (a) mixing at least one first liquid with a second liquid in a coalescing apparatus for substantially residence time, tᵣₑₛ, (b) defining a breakage probability, P_{break}, of said droplets to be P_{break}=f(μ_{d},μ_{c},σ,d,εᵥₒₗᵤₘₑ) where μ_{d} is the viscosity of said at least one first liquid, μ_{c} is the viscosity of said second liquid, σ is the interfacial surface tension of said droplets, and εᵥₒₗᵤₘₑ is the turbulent energy dissipation distribution per volume, (c) defining a coalescence probability, P_{coalescence}, of said droplets to be P_{coalescence}=f(μ_{d},μ_{c},σ,φ,Pᵣ,d,εᵥₒₗᵤₘₑ) where φ is the concentration of said at least one first liquid in said second liquid, and Pᵣ is the restricting pressure at the interface of said droplets, (d) defining a multiplication variable to be equal to (d/dₐᵥ)^{x} where d<dₐᵥ, and (e) controlling said mixing so that a maximum value of the energy dissipation value, εₘₐₓ, is greater than

$$\frac{0.35}{{d}^{*}} {( {P}_{r} / {ρ}_{c} )}^{1.5}$$

where ρ_{c} is the density of the continuous phase.

Furthermore, according to embodiments of the present invention, (d/dₐᵥ)^{x} is smaller than 1 at all times.

Furthermore, according to embodiments of the present invention, a value obtained by multiplying said coalescence probability, P_{coalescence}, by said multiplication variable, is greater than said breakage probability, P_{break}.

Furthermore, according to embodiments of the present invention, d* is the minimal coalescable diameter of droplets for said given coalescing apparatus, and the residence time tᵣₑₛ is greater than 2/(P_{coalescence}(μ_{d},μ_{c},σ,φ,Pᵣ,εᵥₒₗᵤₘₑ,d*)·(d/dₐᵥ)^{x}−P_{break}(μ_{d},μ_{c},σ,d*,εᵥₒₗᵤₘₑ)).

Furthermore, according to embodiments of the present invention, x may range between ⅓ to ⅔.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flow chart illustrating a method used for coalescing droplets in a coalescing apparatus according to embodiments of the present invention;

FIG. 2 is a schematic illustration of a coalescing apparatus-separator system in accordance with embodiments of the present invention;

FIG. 3A is a graph illustrating drop size distribution of an emulsion entering a coalescing apparatus in accordance to embodiments of the present invention;

FIG. 3B is a graph illustrating drop size distribution of an emulsion exiting a coalescing apparatus in accordance to embodiments of the present invention;

FIG. 4A is a flow chart illustrating a method used for utilizing the coalescing apparatus-separator system described in FIG. 2 in accordance with embodiments of the present invention;

FIG. 4B is a continuation of the flow chart given in FIG. 4A; and

FIG. 5 is a graph illustrating droplets' average diameter versus time profiles obtained from experimental measurements and by numerical simulations, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and apparatus for separating immiscible liquids effectively in accordance to embodiments of the present invention are provided herein. Said method and apparatus may allow coalescing of relatively small-sized droplets having a diameter d, said diameter d having a value of d* or larger in a given coalescing apparatus for easing and improving the degree of separation thereafter.

The method may be defined by a system of equations describing the requirements and conditions imposed on the kinetics of drop breaking and coalescence as functions of properties of the involved liquids, involved energy and means for inducing mixing energy into the mixture, such as, but not limited to, viscosity, interfacial tension, droplet diameter distribution, average droplet diameter, average volumetric droplet diameter, concentration of the dispersed liquid in the coalescing apparatus, restricting pressure of the electrostatic double layer surrounding the interfacial boundary of the droplets, and turbulent energy dissipation distribution per volume within the coalescing apparatus.

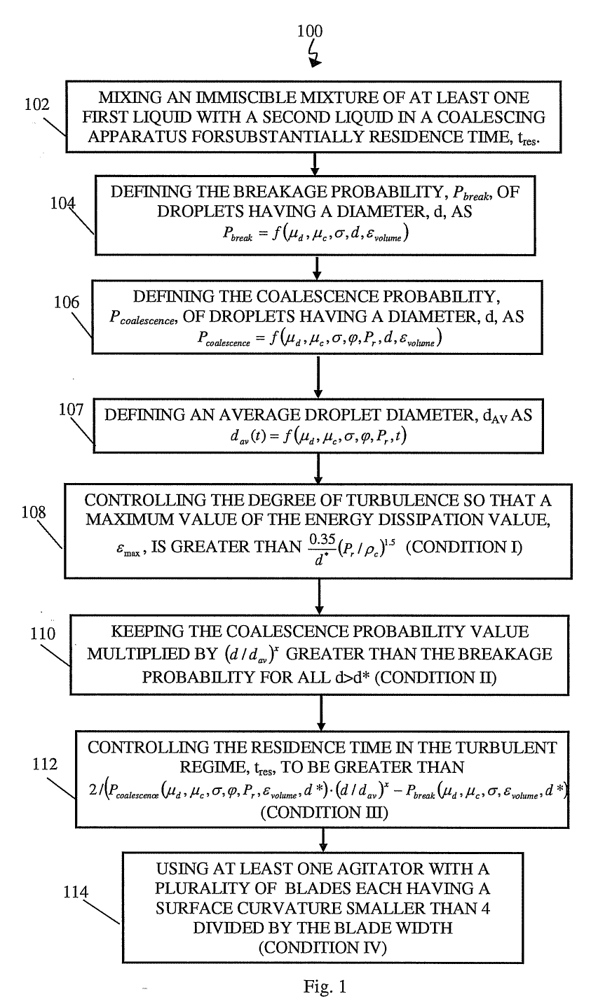

Referring now to FIG. 1 which is a flow chart 100 illustrating a method used for coalescing droplets having a diameter d, said diameter d having a value of d* or larger of at least one first liquid dispersed in a second liquid in a given coalescing apparatus in accordance with embodiments of the present invention.

It is to be understood that d* is the minimal coalescable diameter of droplets for a given coalescing apparatus in accordance to embodiments of the present invention.

The method may comprise mixing an immiscible mixture of at least one first liquid (dispersed phase) with a second liquid (continuous phase) in a coalescing apparatus for substantially residence time, tᵣₑₛ, (block 102).

For the at least one first liquid which is dispersed in the second liquid and includes droplets of various diameters, the breakage probability, P_{break}, of droplets having a diameter, d, may be defined as P_{break}=f(μ_{d},μ_{c},σ,d,εᵥₒₗᵤₘₑ) (block 104), where μ_{d} is the viscosity of the dispersed liquid phase i.e., the viscosity of the at least one first liquid, μ_{c} is the viscosity of the continuous liquid phase i.e., the viscosity of the second liquid, σ is the interfacial surface tension of the droplets, and εᵥₒₗᵤₘₑ is the turbulent energy dissipation distribution per volume.

The coalescence probability, P_{coalescence}, of droplets having a diameter d, may be defined as P_{coalescence}=f(μ_{d},μ_{c},σ,φ,Pᵣ,d,εᵥₒₗᵤₘₑ) (block 106), where φ is the concentration of the dispersed liquid phase in the continuous liquid phase i.e., the concentration of the at least one first liquid in the second liquid, and Pᵣ is the restricting pressure at the interface of the droplets.

The method may further comprise defining the average droplet diameter, dₐᵥ, as dₐᵥ=f(μ_{d},μ_{c},σ,φ,Pᵣ,εᵥₒₗᵤₘₑ) (block 107).

It should be noted that the average diameter of the droplets, the breakage probability, P_{break}, and the coalescence probability, P_{coalescence}, of the droplets may be calculated using known methods described in Leonid N. Braginsky and Yury V. Kokotov, “Kinetics of Break-Up Coalescence of Drops In Mixing Vessels”, International Symposium on Liquid-Liquid Two Phase Flow and Transport Phenomena, Antalya, Turkey, Nov. 3-7, 1997.

The mixing of said at least one first liquid with said second liquid according to embodiments of the present invention may be done by controlling the degree of turbulence so that a maximum value of the energy dissipation value, εₘₐₓ may be greater than

$$\frac{0.35}{{d}^{*}} {( {P}_{r} / {ρ}_{c} )}^{1.5}$$

(Condition I, block 108) where εₘₐₓ is the turbulent energy dissipation value in regions of most intensive turbulence within the coalescing apparatus, ρ_{c} is the density of the continuous phase.

Controlling physical parameters such as, but not limited to the concentration of the at least one first liquid in the second liquid, φ, and the turbulent energy dissipation distribution per volume, εᵥₒₗᵤₘₑ, so that the coalescence probability value P_{coalescence} (μ_{d},μ_{c},σ,φ,Pᵣ,d,εᵥₒₗᵤₘₑ) multiplied by a multiplication variable of (d/dₐᵥ)^{x} (where d<dₐᵥ) is maintained greater than the breakage probability, P_{break} (μ_{d},μ_{c},σᵣ,d,εᵥₒₗᵤₘₑ) for any d greater than d* (Condition II, block 110) where dₐᵥ is the average diameter of the droplets in the coalescing apparatus, (d/dₐᵥ)^{x} is smaller than 1 at all times, and x lies in the range between ⅓ to ⅔ in accordance to embodiments of the present invention.

The method may further comprise controlling the residence time, tᵣₑₛ, to be greater than: 2/(P_{coalescence}(μ_{d},μ_{c},σ,φ,Pᵣ,d*)·f(d*, dₐᵥ)−P_{break}(μ_{d},μ_{c},σ,d*))(Condition III, block 112).

In accordance to embodiments of the present invention, turbulence may be induced by any means, including but not necessarily by the use of at least one agitator having a plurality of blades.

It should be noted, however, that in case that at least one agitator is used for inducing turbulence, the agitator's blades or other surfaces used for the mixing of said at least one first liquid and said second liquid should have a surface curvature smaller than 4 divided by the blade or surface width in order to reduce/minimize the breakup of droplets during the coalescence process (Condition IV, block 114).

It should be noted that for a blade with a varying width, the local surface curvature, should be smaller than k divided by the respective local blade width, where k=4.

While the above-mentioned conditions I-III must be satisfied for coalescing droplets with diameter d having a a value of d* or larger, satisfying condition IV may not be necessary for all emulsions in accordance with embodiments of the present invention.

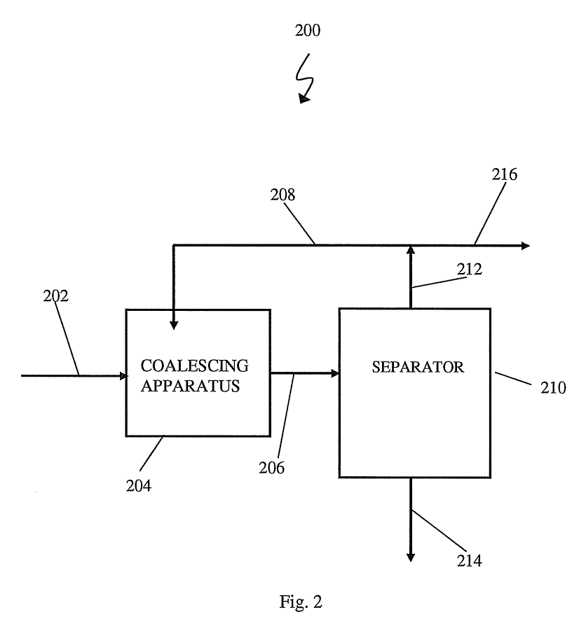

Referring now to FIG. 2 which is a schematic illustration of a coalescing apparatus-separator system 200 in accordance with embodiments of the present invention.

Inlet stream 202 of at least one first liquid dispersed in a second liquid may enter coalescing apparatus 204 wherein the dispersed at least one first liquid contains droplets of various sizes including droplets having diameters ranging between d* and dₘᵢₙ where dₘᵢₙ is a minimal separable diameter in a given separator. After treatment, outlet stream 206 may contain a greater number of droplets having a diameter equal to or greater than dₘᵢₙ compared with the relative situation in inlet stream 202. Furthermore, outlet stream 206 may contain a substantially smaller number of droplets with diameters smaller than dₘᵢₙ compared with the relative situation in inlet stream 202.

Stream 206 exits coalescing apparatus 204 and may enter separator 210 to separate outlet stream 206 into two separated streams e.g., into a first separated stream 212 and a second separated stream 214.

First separated stream 212 may comprise a liquid that is producible from droplets having a diameter equal to or greater than a minimal separable diameter, dₘᵢₙ, where dₘᵢₙ is the minimal diameter of droplets that may be separated in separator 210, i.e., in a given separator. According to embodiments of the present invention the minimal separable diameter dₘᵢₙ, is greater than d*. Therefore, in order to increase the degree of separation, the efficiency of the coalescing process should be optimized so that as many as possible droplets with diameters ranging from d* to dₘᵢₙ should coalesce into larger droplets.

After separation, a portion of first separated stream 212, e.g., stream 208 may be returned back (i.e., recycled) into coalescing apparatus 204, as will be explained in more detail hereinafter.

The recycling scheme, which returns a portion 208 of said first separated stream 212 back to coalescing apparatus 204 may be intended for keeping the concentration φ of the dispersed phase in the continuous phase i.e., the concentration of said at least one first liquid in said second liquid in the coalescing apparatus, within a certain concentration range. The defined concentration may be expressed in normalized value and may be kept, according to embodiments of the present invention, in a substantially predetermined normalized range such as, for example, 0.2-0.3. However, it should be mentioned that for some liquids, it is possible that a different normalized concentration range may also be effective.

A predetermined normalized concentration range such as, for instance, 0.2-0.3 may be required for satisfying the above mentioned condition II. However, it should be noted that keeping the concentration value equal to a predetermined concentration value in coalescing apparatus 204 may not necessarily require the use of a recycle scheme. Instead, an external source of liquid, for example said at least one first liquid, may be used for supplying the dispersed phase to the coalescing apparatus as needed for keeping the concentration value as desired.

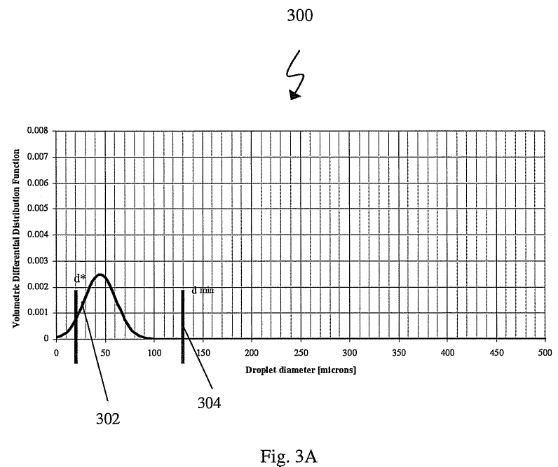

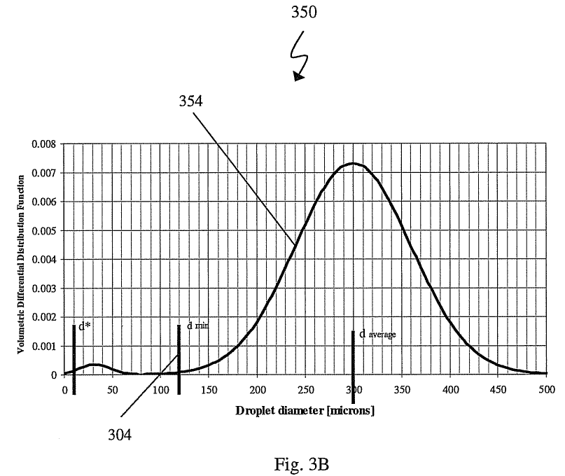

Referring now to FIG. 3A which is a graph illustrating drop size distribution of an emulsion prior to being processed 300 in a coalescing apparatus in accordance to embodiments of the present invention.

Curve 302 defines the droplet size distribution of an emulsion prior to entering into a coalescing apparatus. As seen in the figure, the emulsion contains droplets smaller than the minimal separable diameter, dₘᵢₙ, 304 of a given separator.

Referring now to FIG. 3B which is a graph illustrating drop size distribution of an emulsion after being processed 350 in a coalescing apparatus in accordance to embodiments of the present invention.

Curve 354 defines the droplet size distribution of an emulsion exiting a coalescing apparatus. As seen in the figure, the quantity of droplets having a diameter smaller than the minimal separable diameter, dₘᵢₙ, 304 has substantially decreased as a result of the coalescing process. Similarly, as a result of the coalescing process, a relatively large number of droplets having a diameter larger than the minimal separable diameter, dₘᵢₙ, 304 has formed.

It should be noted that satisfying condition III, i.e. keeping tᵣₑₛ greater than: 2/(P_{coalescence}(μ_{d},μ_{c},σ,φ,Pᵣ,d*)·f(d*,dₐᵥ)−P_{break}(μ_{d},μ_{c},σ,d*)) may be achieved either by manipulating the flow rate of inlet stream 202 into coalescing apparatus 204 and/or the flow rate of treated stream 206 exiting coalescing apparatus 204, or by controlling the volume of liquid in the coalescing apparatus 204. Other methods and means for satisfying the requirements of condition III above may be used, alternatively or concurrently.

In order to keep the residence time, tᵣₑₛ, and the size of the coalescing apparatus not exceedingly large, design specifications, such as, but not limited to, the concentration of the dispersed phase and the turbulence profile in the coalescing apparatus should be such that the value of coalescence probability, P_{coalescence}, multiplied by a multiplication variable of (d/dₐᵥ)^{x} where x lies in the range between ⅓ to ⅔ in accordance to embodiments of the present invention, is significantly larger than the breakage probability, P_{break}.

It should be noted that in accordance to embodiments of the present invention, a coalescing system may include at least one coalescing apparatus 204 and/or at least one separator 210. Similarly, coalescing apparatus 204 may include at least one vessel and at least one agitator.

Furthermore, coalescing apparatus 204 may include at least one baffle for easing and improving the mixing of said at least one first liquid with said second liquid in accordance to embodiments of the present invention.

Separator 210, in accordance with embodiments of the present invention, may be designed based on, but not limited to, various techniques such as centrifugal separation, hydrocyclonic separation, gravitational separation, electrostatic separation and any combination thereof.

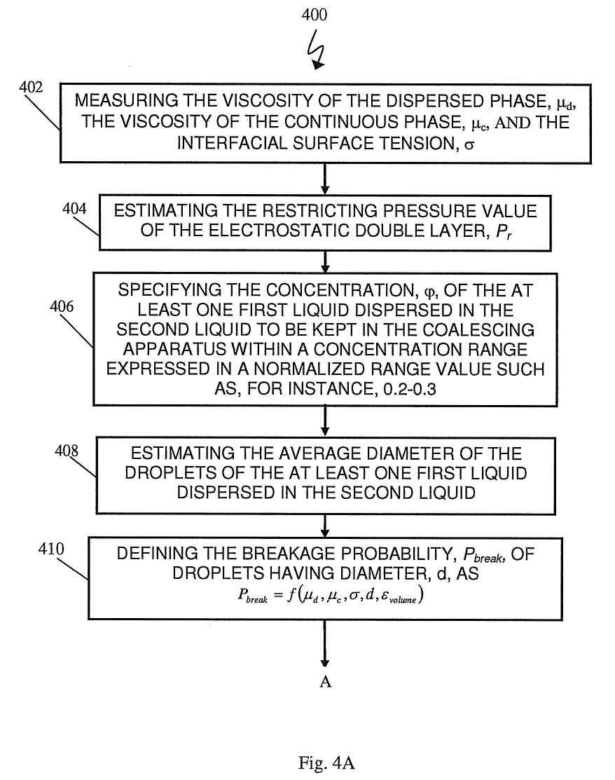

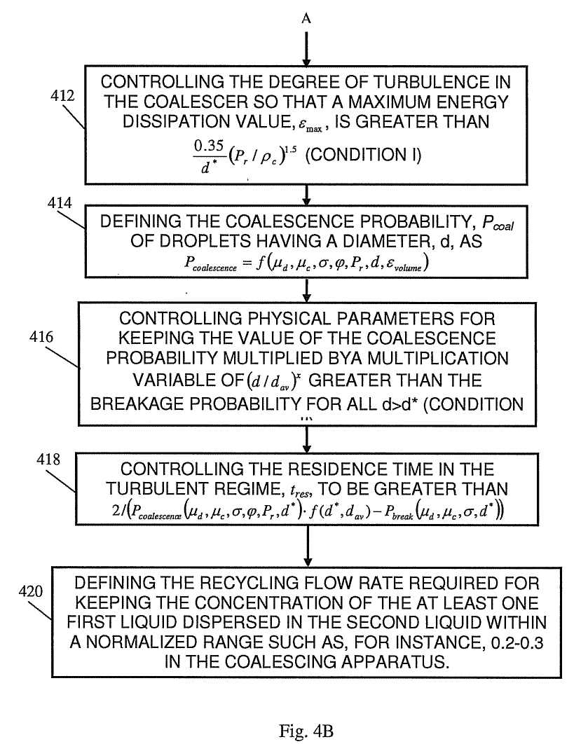

Referring now to FIG. 4A which is a flow chart 400 illustrating a method used for utilizing the coalescing apparatus-separator system described in FIG. 2 in accordance with embodiments of the present invention. The method may comprise measuring the viscosity of the dispersed phase, μ_{d}, the viscosity of the continuous phase, μ_{c}, and the interfacial surface tension, σ (block 402). The method may further comprise estimating the restricting pressure value of the electrostatic double layer, Pᵣ (block 404). In addition, the method may comprise specifying the concentration, φ, of the at least one first liquid dispersed in the second liquid to be kept in the coalescing apparatus within a concentration range expressed in a normalized range value, such as for instance, 0.2-0.3 (block 406).

The average diameter of the droplets of the at least one first liquid dispersed in the second liquid may be estimated by using the following equation.

dₐᵥ(t)=f(μ_{d},μ_{c},σ,φ,Pᵣ,εᵥₒₗᵤₘₑ,t)

where μ_{d}, μ_{c}, and σ are measured experimentally, (block 408).

The breakage probability, P_{break}, of droplets having a diameter d, is defined as P_{break}=f(μ_{d},μ_{c},σ,d,εᵥₒₗᵤₘₑ) (block 410).

Referring now to FIG. 4B which is a continuation of the flow chart given in FIG. 4A. The degree of turbulence within the coalescing apparatus may be controlled in accordance to embodiments of the present invention so that a maximum value of the energy dissipation value, εₘₐₓ, is greater than

$$\frac{0.35}{{d}^{*}} {( {P}_{r} / {ρ}_{c} )}^{1.5}$$

(condition I, block 412). The coalescence probability, P_{coal}, of droplets having a diameter, d, may be defined as P_{coalescence}=f(μ_{d},μ_{c},σ,φ,Pᵣd,εᵥₒₗᵤₘₑ) (block 414).

Physical parameters such as, but not limited to the concentration of the at least one first liquid in the second liquid, φ, and the turbulent energy dissipation distribution per volume, εᵥₒₗᵤₘₑ, may be controlled for having the coalescence probability value P_{coalescence} (μ_{d},μ_{c},σ,φ,Pᵣ,d,εᵥₒₗᵤₘₑ) multiplied by (d/dₐᵥ)^{x} greater than the breakage probability, P_{break}(μ_{d},μ_{c},σᵣ,d,εᵥₒₗᵤₘₑ) for any d greater than d* (Condition II, block 416).

The residence time, tᵣₑₛ, may be controlled to be greater than: 2/(P_{coalescence}(μ_{d},μ_{c},σ,φ,Pᵣ,d*)·f(d*,dₐᵥ)−P_{break}(μ_{d},μ_{c},σ,d*)) which satisfies Condition III (block 418)

The method may further comprise defining a recycling flow rate for keeping the concentration of the at least one first liquid dispersed in the second liquid within a concentration range expressed in normalized values such as but not limited to 0.2-0.3 in coalescing apparatus 420.

It should be noted that keeping the concentration of the at least one first liquid in said second liquid in the coalescing apparatus within a predetermined normalized range such as, for instance, 0.2-0.3 may be essential for the coalescence process since the lower limit of the range, i.e., 0.2 in this case, signifies a value below which condition II may not be satisfied, and the upper limit of the range, i.e., 0.3 in this case, signifies an approximate value above which the emulsion mixture may undergo an inversion meaning that the at least one first liquid may no longer be dispersed in the second liquid, but instead, the second liquid may be dispersed in the at least one first liquid.

It should be noted that for some liquids phase inversion does not occur until normalized concentrations approaching 0.5 or higher.

Since the restricting pressure of the electrostatic double layer, Pᵣ, is not directly measurable, a curve fitting technique may be used for estimating the value of the restricting pressure in accordance with embodiments of the present invention. More specifically, a droplet average diameter versus time profile obtained from experimental measurements may be compared to profiles generated from numerical simulations for various values of the restricting pressure. Then, the correct restricting pressure value may be assumed to be the restricting pressure value used for simulating the profile which best fits the experimental profile.

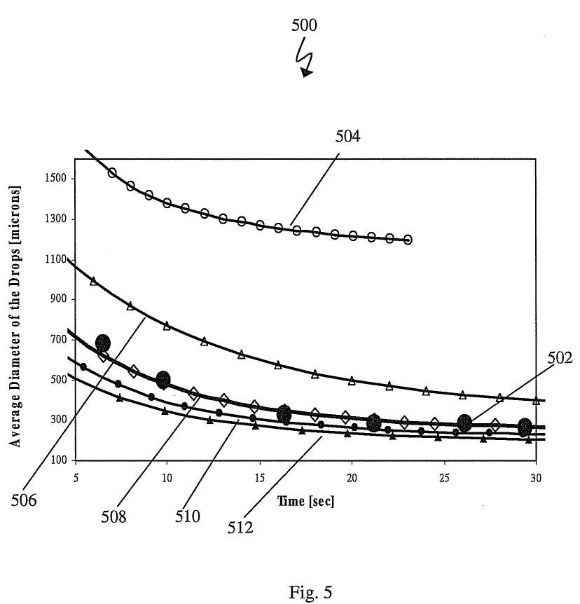

Referring now to FIG. 5 which is a graph illustrating droplets' average diameter versus time profiles 500 obtained from experimental measurements and by numerical simulations, according to embodiments of the present invention. Said numerical simulations may be carried out using commercially available software suitable for hydrodynamic-type calculations.

Dotted curve 502 was generated from experimental measurements while curves 504, 506, 508, 510 and 512 were generated by numerical simulations for restricting pressure values of 4.5 N/m², 10 N/m², 20 N/m², 40 N/m², and 90 N/m² respectively. As seen, curve 508 best fits dotted curve 502; therefore, the restricting pressure value in this case may be assumed to be 20 N/m².

### EXAMPLES

### Example I

### Of a Coalescing Process in which Conditions I-III are Satisfied

A coalescing apparatus-separator system in accordance to embodiments of the present invention was tested for the removal of oil from an aqueous phase. The flow rate of a continuous liquid phase (i.e., aqueous phase) containing 1% oil in the form of droplets of approximately 5 μm into a coalescing apparatus equaled 10 l/h. The oil (dispersed phase) and the aqueous phase (continuous phase) possessed the following properties:
density of the aqueous phase, ρ_{c}, is 1000 kg/m³;
density of the dispersed phase, ρ_{d}, is 900 kg/m³;
dynamic viscosity of the aqueous phase is 1 kg/m³;
dynamic viscosity of the dispersed phase is 3 kg/m³;
interfacial surface tension=0.03 N/m²; and
repulsing pressure=20 N/m².

The coalescing apparatus included:
a vessel 150 mm in diameter;
four vertical baffles; and
an agitator with 8 blades each having a uniform width of about 15 mm and a surface curvature smaller than four divided by said blade's width, i.e., smaller than 4/15 mm⁻¹.

A recycle scheme with a recycle flow rate of 4.3 l/h was used so that the concentration of the dispersed phase in the continuous phase in the coalescing apparatus possesses a normalized value of 0.3.

A commercially available software suitable for hydrodynamic-type calculations was used for calculating the following turbulence properties:
volume of zone in which the turbulent energy dissipation is maximum equals 32 cm³ (which is approximately 1% of the total volume);
maximum value of turbulent energy dissipation, εₘₐₓ equals 450 w/kg;
average droplet diameter dₐᵥ equals 300 μm.
the residence time, tᵣₑₛ, in the coalescing apparatus was about 830 sec.
   In this exemplary process,

$$\frac{0.35}{{d}^{*}} {( {P}_{r} / {ρ}_{c} )}^{1.5}$$

equals 200 W/kg (i.e., smaller than the maximum value of the turbulent energy dissipation, εₘₐₓ, which, as noted earlier, equals 450 w/kg;
therefore, condition I is satisfied.
Breakage probability, P_{break},=0; and
Coalescence probability, P_{coalescence},=0.058;
therefore, Condition II is satisfied.
tᵣₑₛ=830 seconds; and

2/(P_{coalescence}(μ_{d},μ_{c},σ,φ,Pᵣ,d*)·(d*/dₐᵥ)^{2/3}−P_{break}(μ_{d},μ_{c},σ,d*,εᵥₒₗᵤₘₑ))=500 sec;
thus, tᵣₑₛ>500 sec;
therefore, condition III is satisfied.

The separation process was carried out in a settler and took about 0.5 hour. The resulting first separated stream contained oil droplets with an average diameter of about 5 μm. The resulting second separated stream included about 0.21% of oil in aqueous phase, e.g., a percent concentration that is about 5 times lower than the percent concentration of oil in aqueous phase typically obtained in separation processes not including at least one coalescing apparatus.

### Example II

### Of a Coalescing Process in which at Least One of Conditions I-III is Not Satisfied

The process characteristics described above in example I also apply to the current example as well, except the impeller rotation speed which is 500 Rpm in this example. In this case, the energy dissipation in zone of maximum turbulence is 110 W/kg (i.e., smaller than

$$\frac{0.35}{{d}^{*}} {( {P}_{r} / {ρ}_{c} )}^{1.5}$$

which equals 200 W/kg. Therefore, condition I is not satisfied.

The resulting second separated stream included about 0.83% of oil in aqueous phase, e.g., a concentration which is close to the concentration of the oil phase in the aqueous phase of the emulsion prior to entering into the coalescing apparatus. Therefore, the effect of the coalescing process in this case is relatively poor.

### Example III

### Of a Coalescing Process in which at Least One of Conditions I-III is Not Satisfied

The process characteristics described above in example I apply to the current example as well excluding the average droplet diameter which is 2 μm in this case. Energy dissipation in zone of maximum turbulence is 500 W/kg (i.e., greater than:

$$\frac{0.35}{{d}^{*}} {( {P}_{r} / {ρ}_{c} )}^{1.5}$$

which equals 200 W/kg.
therefore, condition I is satisfied.
breakage probability, P_{break},=0; and
coalescence probability, P_{coalescence},=0.03;
therefore, Condition II is satisfied.
tᵣₑₛ=830 seconds; and

2/(P_{coalescence}(μ_{d},μ_{c},σ,φ,Pᵣ,d*)·(d*/dₐᵥ)^{2/3}−P_{break}(μ_{d},μ_{c},σ,d*,εᵥₒₗᵤₘₑ))=1800 sec;
thus, tᵣₑₛ<1800 sec;
therefore, condition III is not satisfied.

The resulting second separated stream included about 1.012% of oil in aqueous phase, e.g., a percent concentration that is greater than the percent concentration of the oil phase in the aqueous phase in the emulsion prior to entering into the coalescing apparatus.

Therefore, in this case, the inclusion of a coalescing apparatus in the separation process worsens the situation.

As illustrated in examples II and III, when at least one of the 3 specified conditions I-III is not satisfied, the coalescing process may not be efficient and may fail to produce the desired results. Therefore, conditions I-III must be satisfied for having an efficient coalescing process in accordance to embodiments of the present invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for coalescing droplets having a diameter d, said diameter d having a value of d* or larger in a given coalescing apparatus, comprising:
mixing at least one first liquid with a second liquid in a coalescing apparatus for substantially residence time, tᵣₑₛ;
defining a breakage probability, P_{break}, of said droplets to be P_{break}=f(μ_{d},μ_{c},σ,d,εᵥₒₗᵤₘₑ) where μ_{d} is the viscosity of said at least one first liquid, μ_{c} is the viscosity of said second liquid, σ is the interfacial surface tension of said droplets, and εᵥₒₗᵤₘₑ is the turbulent energy dissipation distribution per volume;
defining a coalescence probability, P_{coalescence}, of said droplets to be P_{coalescence}=f(μ_{d},μ_{c},σ,φ,Pᵣ,d,εᵥₒₗᵤₘₑ) where φ is the concentration of said at least one first liquid in said second liquid, and Pᵣ is the restricting pressure at the interface of said droplets;
defining a multiplication variable to be equal to (d/dₐᵥ)^{x} where d<dₐᵥ; and
controlling said mixing so that a maximum value of the energy dissipation value, εₘₐₓ, is greater than
$$\frac{0.35}{{d}^{*}} {( {P}_{r} / {ρ}_{c} )}^{1.5}$$
where ρ_{c} is the density of the continuous phase;
wherein:
(d/dₐᵥ)^{x} is smaller than 1 at all times;
a value obtained by multiplying said coalescence probability, P_{coalescence}, by said multiplication variable, is greater than said breakage probability, P_{break};
said d* is the minimal coalescable diameter of droplets for said given coalescing apparatus; and
said residence time tᵣₑₛ is greater than 2/(P_{coalescence}(μ_{d},μ_{c},σ,φ,Pᵣ,εᵥₒₗᵤₘₑ,d*)·(d/dₐᵥ)^{x}−P_{break}(μ_{d},μ_{c},σ,d*,εᵥₒₗᵤₘₑ)).

2. The method of claim 1, wherein said x ranges between ⅓ to ⅔.

3. The method of claim 1, wherein said coalescing apparatus comprises at least one agitator, each of said at least one agitator comprises a plurality of blades, the surface curvature of each of said plurality of blades is smaller than 4 divided by the width of each of said plurality of blades.

4. The method of claim 3, wherein said plurality of blades having a plurality of widths and a plurality of respective local surface curvatures, each of said plurality of surface curvatures is smaller than 4 divided by its respective width.

5. The method of claim 1, further comprises coalescing said droplets having a diameter d equals to d* or larger into droplets having a diameter greater or equal to a minimal separable diameter in a given separator, dₘᵢₙ, said dₘᵢₙ is greater than d*.

6. The method of claim 5, wherein said coalescing apparatus comprises an outlet opening through which an outlet stream is to leave said coalescing apparatus and to enter a separator to separate said outlet stream into a first separated stream and a second separated stream wherein said first separated stream is producible from droplets having a diameter equal to or greater than said minimal separable diameter dₘᵢₙ in a given separator.

7. The method of claim 1 further comprising controlling a normalized concentration value of said at least one first liquid in said second liquid to be between 0.2 to 0.3 in said coalescing apparatus.

8. The method of claim 7, wherein said separator is to separate an inlet stream into a first separated stream and a second separated stream, a portion of said first separated stream is to be returned back into said coalescing apparatus for controlling said normalized concentration value of said at least one first liquid in said second liquid in said coalescing apparatus to be substantially equal to a predetermined normalized concentration value.

9. The method of claim 1, wherein said value obtained by multiplying said coalescence probability, P_{coalescence}, by said multiplication variable is greater than said breakage probability, P_{break}, for d*<d.

10. A coalescing apparatus comprising:
at least one vessel;
at least one agitator placed inside said vessel, said at least one agitator comprises a plurality of blades;
wherein:
the surface curvature of each of said plurality of blades is smaller than 4 divided by the width of each of said plurality of blades.

11. The coalescing apparatus of claim 10, wherein said plurality of blades having a plurality of widths and a plurality of respective local surface curvatures, each of said plurality of surface curvatures is smaller than 4 divided by its respective width.

12. The coalescence apparatus of claim 10, wherein said at least one agitator is adapted to mix at least one first liquid dispersed in a second liquid in said coalescing apparatus for substantially residence time, tᵣₑₛ, said at least one first liquid comprises droplets having a diameter d, said diameter d having a value of d* or larger in a given coalescing apparatus, wherein said coalescence apparatus is operable so that a breakage probability, P_{break}, of said droplets is defined as P_{break}=f(μ_{d},μ_{c},σ,d,εᵥₒₗᵤₘₑ) in said coalescence apparatus where μ_{d} is the viscosity of said at least one first liquid, μ_{c} is the viscosity of said second liquid, σ is the interfacial surface tension of said droplets, and εᵥₒₗᵤₘₑ is the turbulent energy dissipation distribution per volume;
a coalescence probability, P_{coalescence}, of said droplets is defined as P_{coalescence}=f(μ_{d},μ_{c},σ,φ,Pᵣ,d,εᵥₒₗᵤₘₑ) in said coalescence apparatus where φ is the concentration of said at least one first liquid in said second liquid, and Pᵣ is the restricting pressure at the interface of said droplets;
a multiplication variable is defined as (d/dₐᵥ)^{x} where d<dₐᵥ; and
said mixing to be controlled so that a maximum value of the energy dissipation value, εₘₐₓ, is greater than
$$\frac{0.35}{{d}^{*}} {( {P}_{r} / {ρ}_{c} )}^{1.5}$$
where ρ_{c} is the density of the continuous phase;
wherein:
(d/dₐᵥ)^{x} is smaller than 1 at all times;
a value obtained by multiplying said coalescence probability, P_{coalescence}, by said multiplication variable is greater than said breakage probability, P_{break};
said d* is the minimal coalescable diameter of droplets for said given coalescing apparatus; and
said residence time tᵣₑₛ to be greater than 2/(P_{coalescence}(μ_{d},μ_{c},σ,φ,Pᵣ,εᵥₒₗᵤₘₑ,d*)·(d/dₐᵥ)^{x}−P_{break}(μ_{d},μ_{c},σ,d*,εᵥₒₗᵤₘₑ)).

13. The coalescing apparatus of claim 12, wherein said coalescing apparatus is to coalesce droplets having a diameter d* or larger into droplets having a diameter greater or equal to a minimal separable diameter, dₘᵢₙ, in a given separator, said dₘᵢₙ is greater than d*.

14. The coalescing apparatus of claim 13, wherein said coalescing apparatus comprises an outlet opening to allow an outlet stream to leave said coalescing apparatus and to enter a separator to separate said outlet stream into a first separated stream and a second separated stream wherein said first separated stream is producible from droplets having a diameter equal to or greater than said minimal separable diameter, dₘᵢₙ, in a given separator.

15. The coalescing apparatus of claim 12, wherein said x ranges between ⅓ to ⅔.

16. The coalescing apparatus of claim 12, wherein said value obtained by multiplying said coalescence probability, P_{coalescence}, by said multiplication variable, is greater than said breakage probability, P_{break}, for d*<d.

17. The coalescing apparatus of claim 13, wherein a normalized concentration value of said at least one first liquid in said second liquid is controllable to be between 0.2 to 0.3 in said coalescing apparatus.

18. A system comprising:
at least one coalescing apparatus;
at least one separator;
wherein said at least one coalescing apparatus comprises:
at least one vessel; and
at least one agitator placed inside said vessel, said at least one agitator comprises a plurality of blades;
and wherein the surface curvature of each of said plurality of blades is smaller than 4 divided by the width of each of said plurality of blades.

19. The system of claim 18, wherein said plurality of blades having a plurality of widths and a plurality of respective local surface curvatures, each of said plurality of surface curvatures is smaller than 4 divided by its respective width.

20. The system of claim 18, wherein said at least one agitator is adapted to mix at least one first liquid dispersed in a second liquid in said coalescing apparatus for substantially residence time, tᵣₑₛ, said at least one first liquid comprises droplets having a diameter d, said diameter d having a value of d* or larger in a given coalescing apparatus, wherein said system is operable so that a breakage probability, P_{break}, of said droplets is defined as P_{break}=f(μ_{d},μ_{c},σ,d,εᵥₒₗᵤₘₑ) in said coalescence apparatus where μ_{d} is the viscosity of said at least one first liquid, μ_{c} is the viscosity of said second liquid, σ is the interfacial surface tension of said droplets, and εᵥₒₗᵤₘₑ is the turbulent energy dissipation distribution per volume;
a coalescence probability, P_{coalescence}, of said droplets is defined as P_{coalescence}=f(μ_{d},μ_{c},σ,φ,Pᵣ,d,εᵥₒₗᵤₘₑ) in said coalescence apparatus where φ is the concentration of said at least one first liquid in said second liquid, and Pᵣ is the restricting pressure at the interface of said droplets;
a multiplication variable is defined as (d/dₐᵥ)^{x} where d<dₐᵥ; and
said mixing to be controlled so that a maximum value of the energy dissipation value, εₘₐₓ, is greater than
$$\frac{0.35}{{d}^{*}} {( {P}_{r} / {ρ}_{c} )}^{1.5}$$
where ρ_{c} is the density of the continuous phase;
wherein:
(d/dₐᵥ)^{x} is smaller than 1 at all times;
a value obtained by multiplying said coalescence probability, P_{coalescence}, by said multiplication variable is greater than said breakage probability, P_{break};
said d* is the minimal coalescable diameter of droplets for said given coalescing apparatus; and
said residence time tᵣₑₛ to be greater than 2/(P₁coalescence(μ_{d},μ_{c},σ,φ,Pᵣ,εᵥₒₗᵤₘₑ,d*)·(d/dₐᵥ)^{x}−P_{break}(μ_{d},μ_{c},σ,d*,εᵥₒₗᵤₘₑ)).

21. The system of claim 20, wherein said at least one coalescing apparatus to coalesce said droplets having a diameter d* or larger into droplets having a diameter greater or equal to a minimal separable diameter, dₘᵢₙ, in a given separator, said dₘᵢₙ is greater than d*.

22. The system of claim 21, wherein said at least one coalescing apparatus comprises an outlet opening to allow an outlet stream to leave said at least one coalescing apparatus and to enter said at least one separator to separate said outlet stream into a first separated stream and a second separated stream; wherein said first separated stream is producible from droplets having a diameter greater or equal to said minimal separable diameter, dₘᵢₙ.

23. The system of claim 22, wherein said x ranges between ⅓ to ⅔.

24. The system of claim 21, wherein said value obtained by multiplying said coalescence probability, P_{coalescence}, by said multiplication variable, is greater than said breakage probability, P_{break}, for d*<d.

25. The system of claim 21, wherein a normalized concentration value of said at least one first liquid in said second liquid is controllable to be between 0.2 to 0.3 in said coalescing apparatus.

26. The system of claim 22, wherein said at least one separator is adapted to separate an inlet stream into a first separated stream and a second separated stream, a portion of said first separated stream is to be returned back into said at least one coalescing apparatus.
